(19) United States
(12) Patent Application Publication
(10) Pub. No.: US 2011/0095461 A1
(43) Pub. Date: Apr. 28, 2011

(54) ELASTIC ASSEMBLY AND SLIDE MECHANISM USING THE SAME

(75) Inventors: FAN-ZHE DING, Shenzhen City (CN); CHIA-HUA CHEN, Shindian (TW)

(73) Assignees: SHENZHEN FUTAIHONG PRECISION INDUSTRY CO., LTD., ShenZhen City (CN); FIH (HONG KONG) LIMITED, Kowloon (HK)

(21) Appl. No.: 12/766,997

(22) Filed: Apr. 26, 2010

(30) Foreign Application Priority Data
Oct. 27, 2009 (CN) 200920313420.X

(51) Int. Cl. F16F 1/20; F16F 1/26

(52) U.S. Cl. 267/165

(57) ABSTRACT

An elastic assembly for a portable electronic device includes at least two springs and two bushings. Each spring has a different curvature radius and two annular connecting portions at two ends, the connecting portion of each spring having a different diameter relative other connecting portion of other springs. The springs are substantially arranged in a plane, the two connecting portions of each spring are respectively coiled around and secured to another two connecting portion of another spring, the two bushings are respectively secured to the two connecting portion having the smallest diameter. The disclosure also discloses a slide mechanism using the elastic module.

### BACKGROUND

1. Technical Field

The disclosure relates to an elastic assembly and a slide mechanism using the elastic module.

2. Description of Related Art

Typical slide-type portable electronic devices have a cover, a housing, and a slide mechanism connecting the cover to the housing. The slide mechanism enables the cover to slide over the housing, opening or closing the portable electronic device.

Slide mechanisms for slide-type portable electronic devices usually include a linear spring. The linear spring is typically too small to provide sufficient compression for the portable electronic devices. The linear spring is also weaker, so it easily fails with repeated use.

Therefore, there is room for improvement within the art.

### BRIEF DESCRIPTION OF THE DRAWINGS

Many aspects of the present disclosure can be better understood with reference to the following drawings. The components in the various drawings are not necessarily drawn to scale, the emphasis instead being placed upon clearly illustrating the principles of the present disclosure. Moreover, in the drawings, like reference numerals designate corresponding parts throughout the diagrams.

FIG. 1 is an exploded view of an elastic assembly according to an exemplary embodiment.

FIG. 2 is an assembled view of the elastic assembly shown in FIG. 1.

FIG. 3 is an exploded view of an elastic assembly according to another exemplary embodiment.

FIG. 4 is an assembled view of the elastic assembly shown in FIG. 1.

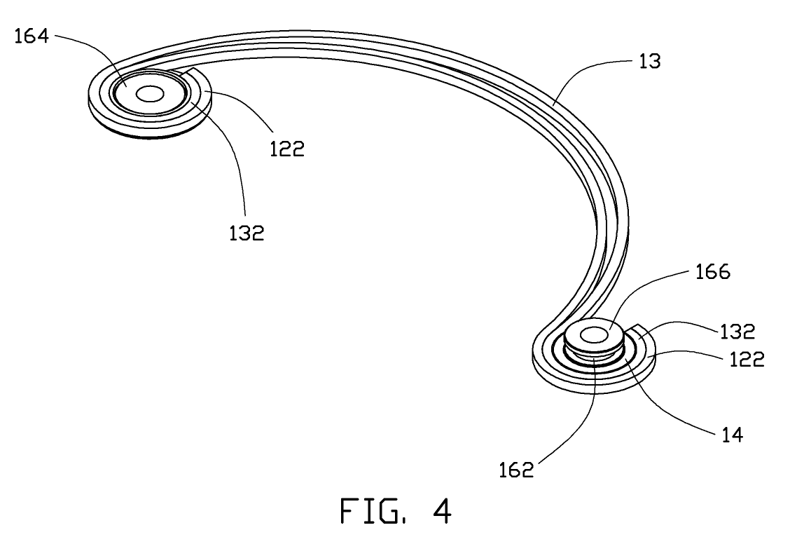

FIG. 5 is a schematic view of a slide mechanism using the elastic assembly shown in FIG. 4 in closed position.

FIG. 6 is a schematic view of the slide mechanism shown in FIG. 5 in open position.

FIG. 7 is a schematic view of a portable electronic device using the slide mechanism shown in FIG. 5.

### DETAILED DESCRIPTION

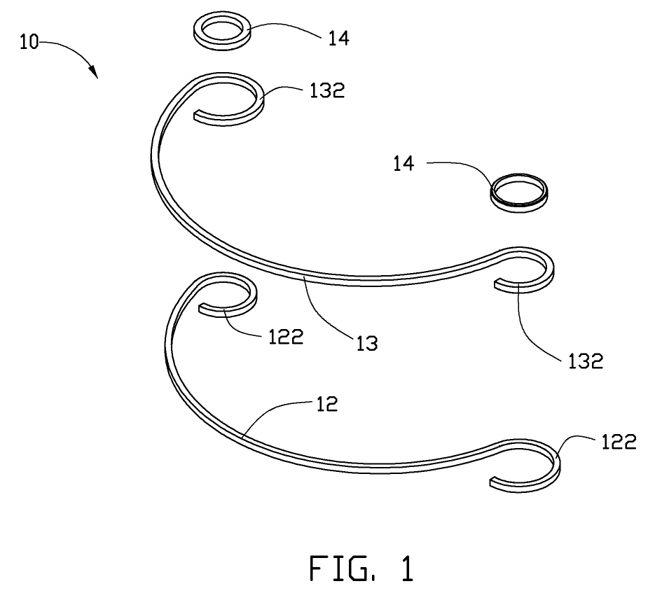

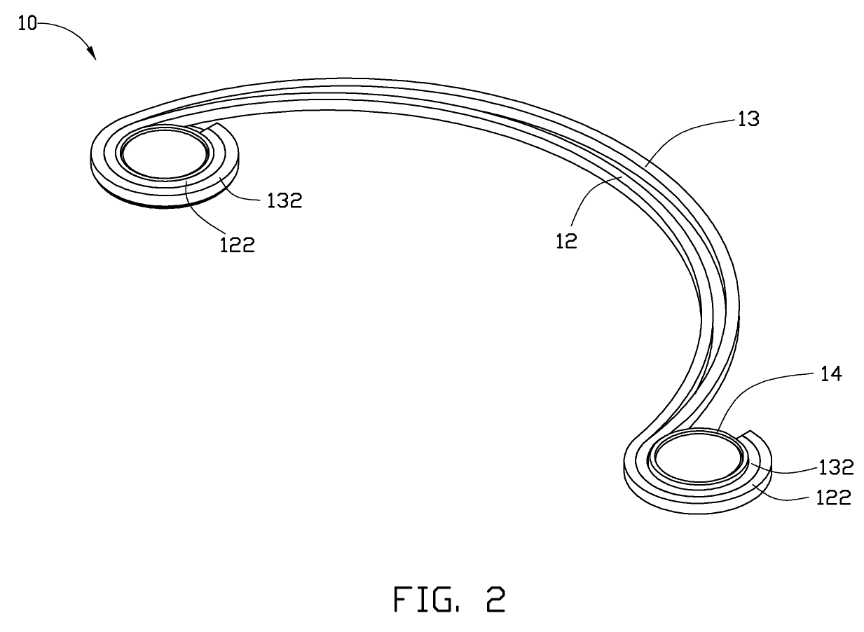

FIGS. 1 and 2 show an exemplary embodiment of an elastic assembly 10 which can be used in a slide mechanism of a portable electronic device such as a mobile phone, or PDA (personal digital assistant), for example. The elastic assembly 10 includes a first spring 12, a second spring 13 and two bushings 14.

The first spring 12 and the second spring 13 can be arcuate and made of metal or other hard, pliable material such as plastic. Each of the first and second springs 12 and 13 has a rectangular or round cross-section, for example. The first spring 12 forms annular first connecting portions 122 at the two ends. The second spring 13 can be arcuate and has a different curvature radius than the first spring 12. The second spring 13 forms annular second connecting portions 132 at the two ends. The first connecting portion 122 can be coiled around and can be welded to the second connecting portion 132. The bushing 14 can be received in and can be welded to the smaller diameter connecting portion from one of the first connecting portions 122 or the second connecting portion 132.

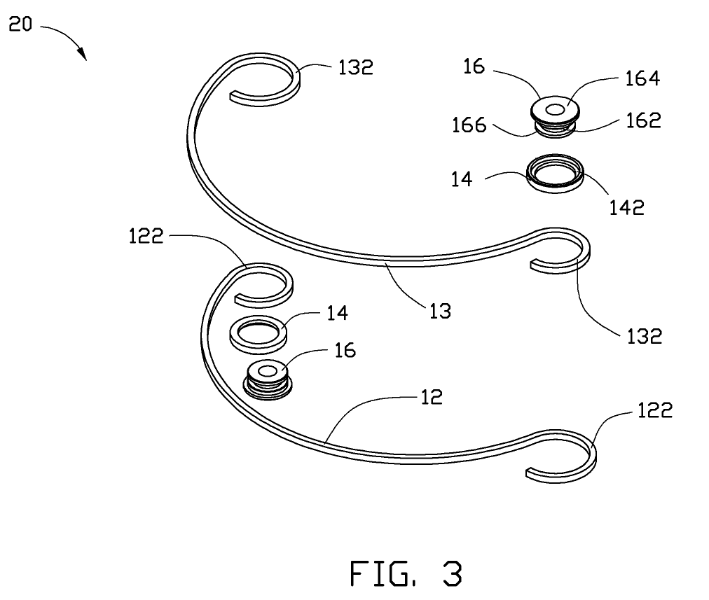

Referring to FIG. 3, the elastic assembly 10 can further include two shaft members 16. Each shaft member 16 rotatably engages with the bushing 14. The shaft member 16 includes a shaft portion 162, a first end portion 164, and a second end portion 166. The first and the second end portions 164 and 166 are larger in diameter than the shaft portion 162, and the first end portion 164 has a larger diameter than the second end portion 166. The shaft portion 162 and the second end portion 164 can pass through bushing 14. In order to engage the bushing 14, the bushing 14 defines an annular receiving groove 142 at an end, the receiving groove 142 has a same diameter as the first end portion 164.

During assembly of the elastic assembly 10, the first spring 12 and the second spring 13 are substantially in the same plane and the first connecting portion 122 engages with and welds to the second connecting portion 132. The bushing 14 is placed into and welds to the smaller diameter connecting portion from one of the first connecting portions 122 and the second connecting portions 132. The shaft member 16 is assembled to the bushing 14. The shaft portion 162 and the first end portion 164 pass through the bushing 14. The second end portion 166 is substantially received in the receiving groove 142. Therefore, the elastic assembly 10 is assembled.

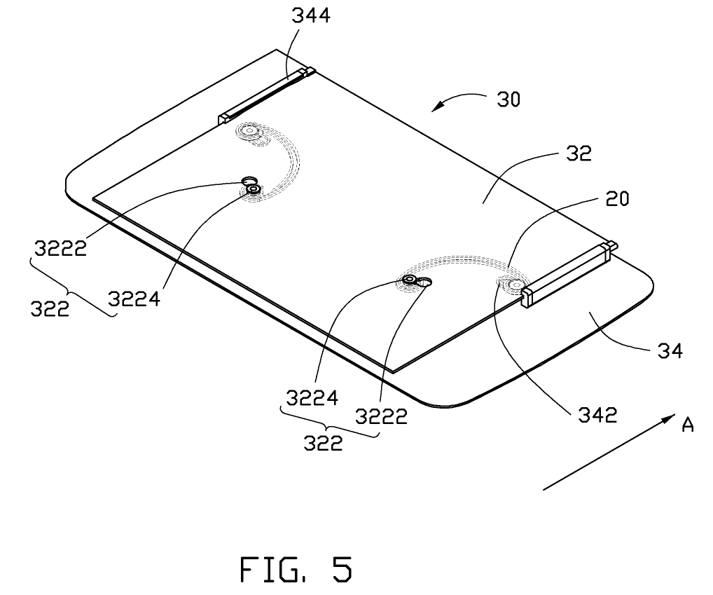

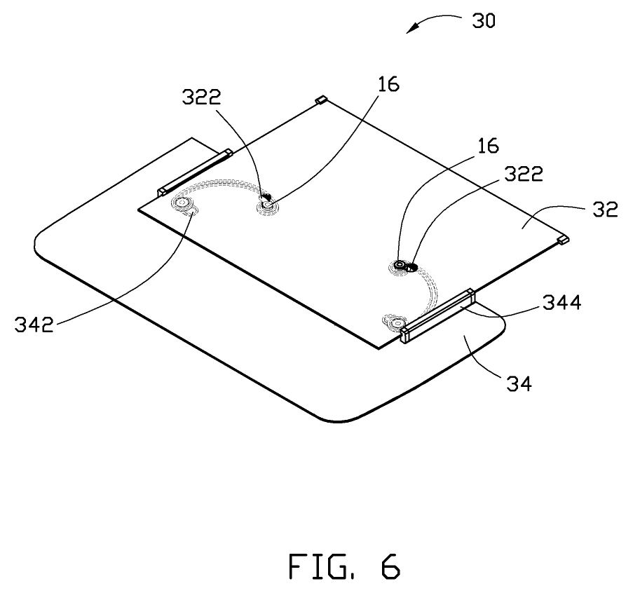

Referring to FIGS. 5 and 6, the elastic assembly 10 is applied to a slide mechanism 30. The slide mechanism 30 includes an upper plate 32 and a lower plate 34. The upper plate 32 defines two first assembly holes 322 to assemble ends of the elastic assembly 10. The first assembly hole 322 includes a first hole portion 3222 and a second hole portion 3224 communicating with the first hole portion 3222, and the first hole portion 3222 is larger than the second hole portion 3224. The first hole portion 3222 has the same diameter as the second end portion 166 of the shaft member 16. The diameter of the second hole portion 3224 in general, corresponds to the diameter of the shaft portion 162. The second end portion 166 can run through the first hole portion 3222 and the shaft portion 162 can slide into and be received the second hole portion 3224, thus, the second end portion 166 cannot pull out from the second hole portion 3224. The lower plate 34 defines two second assembly holes 342 to assemble the other ends of the elastic assembly 10, and the second assembly hole 342 is structurally the same as the first assembly hole 322. The lower plate 34 also forms two parallel rails 344 for slidably engaging with two sides of the lower plate 34.

To assemble the slide mechanism 30, the two sides of the upper plate 32 engage with the two rails 344 of the lower plate 34. The two elastic assemblies 10 are assembled between the upper plate 32 and the lower plate 34. The second end portion 166 runs through the first hole portion 3222 of the upper plate 32, then, the shaft portion 162 is pulled laterally and slid into the second hole portion 3224. Meanwhile, the second end portion 166 cannot pass through the second hole portion 3224. Thus, an end of the elastic assembly 10 is positioned in the second hole portion 3224. The other end of the elastic assembly 10 is positioned in the lower plate 34 by the same way as described above. The first spring 12 and the second spring 13 are compressed between the first assembly hole 322 and the second assembly hole 342. The two shaft portions 162 can be firmly secured in the second hole portions 3224. Therefore, the slide mechanism 30 is assembled.

When subjected to an external force, the upper plate 32 slides along direction A shown in FIG. 5. The first spring 12 and the second spring 13 compress and accumulate potential energy. After the upper plate 32 slides over a predetermined position, the first spring 12 and the second spring 13 release the potential energy, and the upper plate 32 slides automatically until the slide mechanism 30 opens. During this course, the first spring 12 and the second spring 13 restore to their original states.

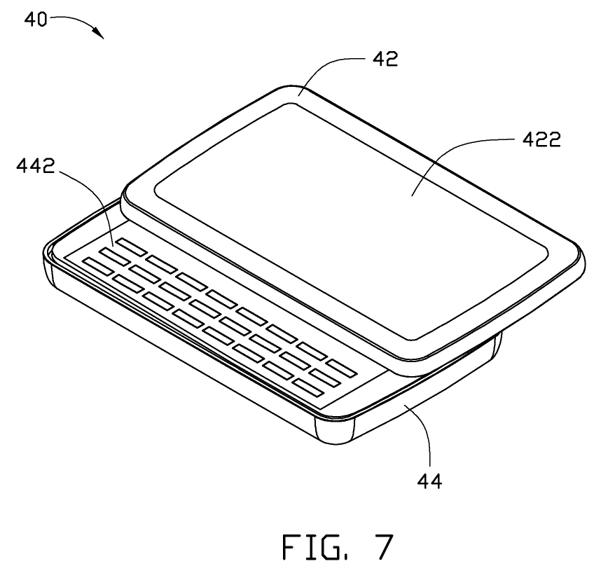

Referring to FIG. 7, the slide mechanism 30 is applied in a portable electronic device 40 such as a mobile phone. The electronic device 40 includes a cover 42 and a housing 44 engageable with the cover 42. The cover 42 forms a display screen 422, the housing 44 has a plurality of keys 442 arranged thereon. The cover 42 is secured to the upper plate 32, and the housing 44 is secured to the lower plate 34. Thus, the portable electronic device 40 opens or closes with the slide mechanism 30.

It is noteworthy that, the shaft member 16 can be omitted, in this case the elastic assembly 10 is connected to the upper plate 32 and the lower plate 34 by the bushing 14.

It is noteworthy that, the elastic assembly can have at least two springs structurally the same as the first and second springs 12 and 13. Where all of the springs are arranged and are secured by their ends.

It is to be understood that even though numerous characteristics and advantages of the present embodiments have been set forth in the foregoing description, together with details of structures and functions of various embodiments, the disclosure is illustrative only, and changes may be made in detail, especially in matters of shape, size, and arrangement of parts within the principles of the disclosure to the full extent indicated by the broad general meaning of the terms in which the appended claims are expressed.

What is claimed is:

1. An elastic assembly for a portable electronic device, comprising:
at least two springs, each spring having a different curvature radius and two annular connecting portions at two ends, the connecting portion of each spring having a different diameter relative other connecting portion of other springs; and
two bushings;
wherein the springs are substantially arranged on a plane and secured with their ends, the two bushings are respectively secured to the two connecting portions having the smallest diameter.

2. The elastic assembly as claimed in claim 1, wherein the at least two springs include a first spring and a second spring, the first spring has two first connecting portions at two ends, the second spring has two second connecting portions to weld to the two first connecting portions respectively.

3. The elastic assembly as claimed in claim 1, wherein the spring is arcuate and has a rectangular cross-section.

4. An elastic assembly for a portable electronic device, comprising:
at least two springs, each spring having a different curvature radius and two annular connecting portions at two ends, the connecting portion of each spring having a different diameter relative other connecting portion of other springs;
two bushings; and
two shaft members;
wherein the springs are substantially arranged in a plane, the two connecting portions of each spring are respectively coiled around and secured to another two connecting portion of another spring, the two bushings are respectively secured to the two connecting portion having the smallest diameter, the shaft members respectively rotatably engages into the two bushings.

5. The elastic assembly as claimed in claim 4, wherein the at least two springs include a first spring and a second spring, the first spring has two first connecting portions at two ends, the second spring has two second connecting portions to weld to the two first connecting portions respectively.

6. The elastic assembly as claimed in claim 4, wherein the shaft member includes an shaft portion, a first end portion forming at an end of the shaft portion, the shaft portion passes through the bushing and the bushing defines an annular receiving groove to receive the first end portion.

7. The elastic assembly as claimed in claim 4, wherein the shaft member includes a second end portion at the other end of the shaft portion, the second end portion has a smaller diameter than the inner diameter of the bushing and can pass through the connecting bush.

8. An slide mechanism for a portable electronic device, comprising:
an upper plate;
a lower plate;
an elastic assembly connecting to the upper plate and the lower plate;
wherein the at least two springs include at least two springs, two bushings, and two shaft members; each spring has a different curvature radius and two annular connecting portions at two ends, the connecting portion of each spring has a different diameter relative other connecting portion of other springs; the springs are substantially arranged in a plane, the two connecting portions of each spring are respectively sleeved with and secured to another two connecting portion of another spring, the two bushings are respectively secured to the two connecting portion having the smallest diameter, the shaft members respectively rotatably engages into the two bushings, one of the shaft members is secured to the upper plate, and the other shaft member is secured to the lower plate.

9. The slide mechanism as claimed in claim 8, wherein the at least two springs include a first spring and a second spring, the first spring has two first connecting portions at two ends, the second spring has two second connecting portions to weld to the two first connecting portions respectively.

10. The slide mechanism as claimed in claim 9, wherein the shaft member includes an shaft portion, a first end portion and the second end portion, the first end portion has a larger diameter than the second end portion larger than the shaft portion in diameter, the second end portion and the shaft portion passes through the connecting bush, and the bushing defines an annular receiving groove to receive the first end portion.

11. The slide mechanism as claimed in claim 10, wherein the upper plate and the lower plate respectively define an assembly hole to secure with the corresponding shaft member.

12. The slide mechanism as claimed in claim 11, wherein the assembly hole includes a first hole portion and a second hole portion communicating with the first hole portion, the first hole portion is larger than the second hole portion, the first hole portion corresponds to the second end portion in diameter, the second hole portion has the same diameter as the shaft portion and can receive the shaft portion therein.
